(19) United States
(12) Patent Application Publication
(10) Pub. No.: US 2011/0299458 A1
(43) Pub. Date: Dec. 8, 2011

(54) VoIP CALL OVER WIRELESS SYSTEMS USING ANY PREFERRED DIALING NUMBER

(75) Inventor: Parwiz Shekalim, Netanya (IL)

(73) Assignee: Runcom Technologies Ltd., Rishon Lezion (IL)

(21) Appl. No.: 13/021,841

(22) Filed: Feb. 7, 2011

Related U.S. Application Data
(60) Provisional application No. 61/302,142, filed on Feb. 7, 2010.

(51) Int. Cl. H04W 4/00; H04L 12/66

(52) U.S. Cl. 370/328; 370/352

(57) ABSTRACT

A method of establishing a communication connection, by a communication unit. A telephone number of a destination is received through a human interface of the communication unit and transmitted over a data connection to a number translation server. Responsive thereto an identifier of the destination for VoIP communications is used to establish a real time communication connection between the communication unit and the destination over a data connection, using the identifier.

### CROSS-REFERENCE TO RELATED APPLICATIONS

The present application claims priority from U.S. provisional patent application 61/302,142, filed Feb. 7, 2010, the contents of which are hereby incorporated by reference.

### FIELD AND BACKGROUND OF THE INVENTION

The present invention relates to communication systems and methods, and, particularly to VoIP (Voice over IP) services. In the Broadband wireless communication systems which are based on IP or packet switched technologies such as WiFi (Wireless Local Area Networks based on IEEE802.11), WiMAX (Worldwide Interoperability for Microwave Access) (Based on IEEE802.16) or LTE (Long Term Evolution defined by 3GPP), no specific protocols are defined by IEEE802.11, IEEE802.16 or 3GPP Rel 7, 8, 9, 10 and beyond for Voice or Video applications. Different protocols or technologies could be used for enabling voice services such as Voice over Internet Protocol (VoIP). The Session Initiation Protocol (SIP) is an example of a VoIP protocol which could be used. SIP is a signaling protocol, widely used for controlling multimedia communication sessions such as voice and video calls over Internet Protocol (IP).

Voice Traffic as a Data Traffic

The transmission networks and systems such as WiMAX, HSPA (High speed packet access) or LTE may handle Voice or Video traffic like other data traffic. However, the Service providers or operators may differentiate between different kinds of traffic and apply different accounting and charging policies to VoIP compared to other data types, while the VoIP services are still handled like other services in the network but with a different QoS (Quality of Service) level. There are some applications such as SKYPE which enable VoIP service using the operators' networks.

### SUMMARY OF THE INVENTION

Broadband wireless technologies such as WiFi/IEEE802.11, WiMAX/IEEE802.16 or HSPA/LTE systems may handle Voice or Video traffic as data traffic, but with different levels of QoS and priorities than the other data traffic types, if required. Session Initiation Protocol (SIP) is an example of VoIP technology which is usually used to provide Voice service in the wireless broadband systems.

To support SIP services, there are some physical or logical protocol components in the network such as UAC (User Agent Client, SIP client), UAS (User Agent Server), Redirect Server, Proxy Server, Registrar, etc'. These components might be collocated in the same location or entity or distributed in the network. The SIP voice or video traffic is initiated and generated, routed and terminated in the network by using of the SIP Agent, SIP Proxy, routers, SIP Server, etc'.

Each resource of a SIP network, such as a User Agent or a voicemail box, is identified by a Uniform Resource Identifier (URI) syntax or a SIP addressing format, based on the general standard syntax also used in Web services and e-mail. A typical SIP URI is of the form: sip:username:password@host:port, according to RFC 3261 of the IETF Network Working Group. Different addressing syntax such as URL, IP addresses, or SIP number which allocated by the service provider can be used as well.

The caller party who initiates or originates a voice call, uses a Uniform Resource Identifier (URIs), that can be digits (a telephony URI, like tel:+1-555-123-4567) or alphanumeric identifiers (a SIP URI, like sip:john.doe@example.com) or IP address of the callee party. According to some embodiments of the current invention, the caller party dials the Public Switched Telephone Network (PSTN) (E.163/E.164 telephone numbers) or MSISDN telephone number of the callee party, while using a wireless network such as IEEE802.11/16 or 3GPP/LTE systems. A SIP VoIP session will be generated wherein the PSTN or MSISDN telephone number of the callee party will be converted to a standard SIP address of the callee party. For an embodiment of the current invention, any other preferred numbering or addressing format or type can be registered and used instead of the PSTN or MSISDN numbers. The system will convert the registered number or address of the subscriber to a standard SIP addressing format. The PSTN or MSISDN numbering follow the numbering plan defined in the ITU-T recommendation E.164 or any format numbering defined by the operator or service provider. The current invention is not limited to the MSISDN or PSTN numbers, but rather covers any unique identification as defined by the service operator, the user or any other entity. It could be any preferred numbers or identification, or any numbering or addressing format or structure, as far as it uniquely refers to a subscriber. This method enables the SIP caller party (who initiates a call) to make a call from his/her/its mobile phone to a callee party by using the “callee party PSTN” number or the “callee party MSISDN” number or any other numbering or addressing which registered uniquely for the callee party. According to the current invention, there is no need of any specific SIP numbering method for generate and received VoIP call using SIP session.

It should be noted that the Voice service is referring to any SIP enabled applications and services such as VoIP or Video, streaming multimedia distribution, instant messing, presence information, online games, etc'.

For simplicity, the current invention is called “Free-call system”. The FreeCall system enables registered users to originate and receive calls on their smart phone, hand set or any other Voice enabled device Voice over IP (VoIP) using the standard mobile number (MSISDN) or PSTN. The advantage of using user's MSISDN or PSTN over VoIP is the caller only has to know the users current mobile or POTS number, and in most cases this number is already stored in the caller party's handset anyway.

SIP (Session Initiation Protocol) VOIP clients are wide spread on smart phones like iPhone, HTC or Samsung handsets, and usually allow the caller to use the normal address book in the phone to make calls. The FreeCall system will utilize either the native SIP client (Symbian) or use a third party SIP client (iPhone) to connect to the system's VoIP server and allow calls. Installing these applications is very easy and configuration should be trivial. However, this depends on 3rd party application.

The proposed solution is not limited to the PSTN or MSISDN numbering of the users only, but it may include any identification of the users as long as the system can recognize the caller and callee parties and adapting their identifications to a standard SIP addressing syntax or format. The proposed solution may further include other VoIP systems such as H.323.

There is therefore provided in accordance with an embodiment of the present invention a method which enables originating and receiving VoIP (Voice over Internet Protocols) calls over wireless networks, using of the standard mobile number MSISDN or standard PSTN number of the subscriber.

The method optionally operates with a SIP enabled application and/or service such as VoIP or Video, streaming multimedia distribution, instant messing, presence information and/or online games.

The method may include receiving a dialing identification (DI) formed of digits or alphanumeric identifiers or IP address of any preferred number, address, format, method or syntax as per Subscriber or Service Provider preference.

Optionally, the subscriber dialing identification is registered in the system, correlated uniquely with a VoIP identification of the subscriber. When a subscriber originates a VoIP call using a preferred dialing identification of the callee party, the system optionally converts the dialing identification number or address to a standard VoIP numbering or addressing format or syntax of the callee party.

Users optionally may connect to the system using a SIP trunk to a corporate IP PBX. Optionally, the system allows calling registered users from the corporate offices with fallback to PSTN or cellular systems.

Optionally, the conversion of PSTN number of callee party to a SIP addressing or numbering format of the callee party is done in the subscriber unit or in the dedicated servers or entities in the SIP network; and the subscriber unit could be a smart phone, mobile phone or any other device used by the subscriber to generate a call.

### BRIEF DESCRIPTION OF DRAWINGS

FIG. 1a: illustrates generating and receiving calls, using an operator or Service Provider network;

FIG. 1b: illustrates generating and receiving calls, using any preferred numbering or addressing format;

FIG. 1c: illustrates generating and receiving call in different systems;

FIG. 2: illustrates general architecture and concept of the system and the major entities;

FIG. 3: illustrates a block diagram of the SW applications;

FIG. 4: illustrates a database schema as an embodiment of the invention

FIG. 5: shows example of procedure for a new user sign-up;

FIG. 6: shows the example of incoming PSTN Gateway call procedure as an exemplary case; and

FIG. 7: shows example of procedure for making an outgoing call.

### DETAILED DESCRIPTION

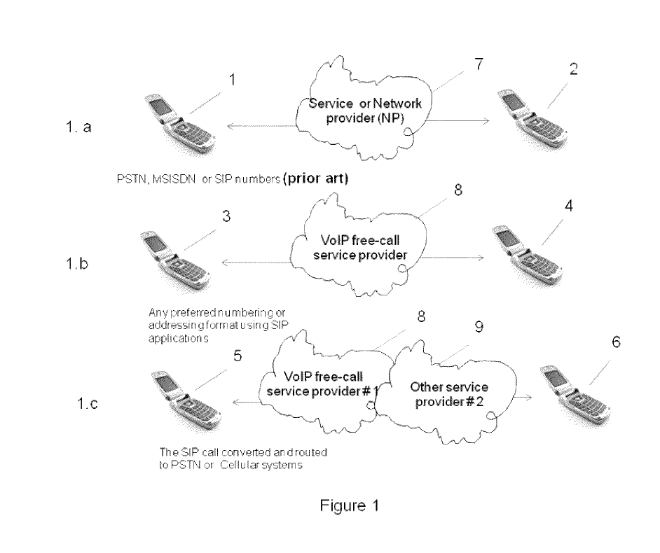

FIG. 1a shows the current concept for originating Voice application connections, where the operator or service provider provides voice services and allocates a unique number to each subscriber, as known in the art. Subscriber 1 is known and authenticated by the VoIP service provider 7, and reach subscriber 2 in the same or other network. Subscriber 1 dials the PSTN or SIP or MSISDN phone number of the callee party which was allocated by the service provider.

FIG. 1b illustrates an embodiment of the present invention. For simplicity purposes the term “free-call” is used in referring to a system in accordance with an embodiment of the present invention. Subscriber 3 subscribes to the Free-call VoIP services and originates a call to the User 4 who may or may not be a subscriber of the “free-call” services. In case User 4 is a subscriber of the “free-call” services, subscriber 3 uses the phone number of subscriber 4 which may be PSTN or MSISDMN or any other numbering or addressing or syntax format, to reach subscriber 4. Subscribers 3 and 4 of the “free-call” system will have SIP VoIP services using a network operator, while their voice service is handled as a data service and they will be charged for a data service rather than a Voice service.

FIG. 1c shows another embodiment of the present invention in which User 6 is not subscriber of the “free-call” services, but still subscriber 3 of the “free-call” services can reach user 6 by dialing of the phone number of user 6 as defined by his operator.

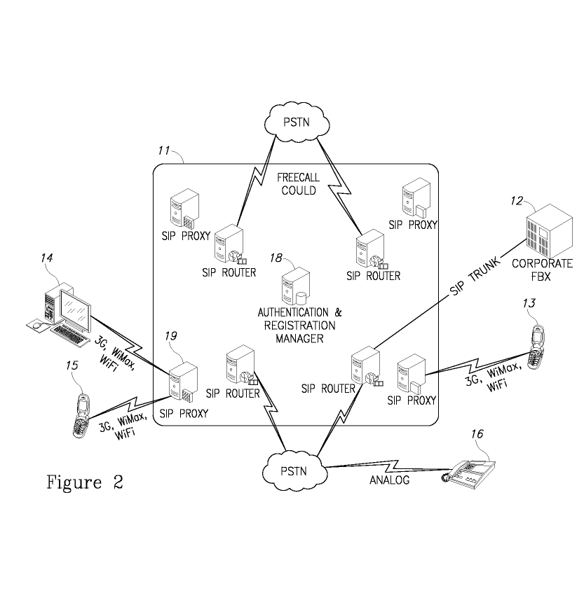

FIG. 2 shows a general architecture and concept of a communication network 11 employing an authentication and registration manager 18, in accordance with an embodiment of the present invention. Network 11 optionally includes SIP proxies 19 and SIP routers which do not necessarily need to be adapted in order to implement embodiments of the present invention. The “free-call” end users 13, 14 and 15 may use WiFi, WiMAX, LTE, PSTN, DSL, or any other 3G or 4G networks or terminals to connect to manager 18. A user dials any preferred numbering or addressing format of the destination which is registered in manager 18.

A free-call software on “free-call” end users 13, 14 and 15 transmits the dialed numbering or addressing format to manager 18 over a communication connection. Optionally, the free-call software is configured with a telephone number or address of manager 18 which is used to transmit the input telephone number to manager 18. The transmission of the dialed number to manager 18 is optionally performed on a data connection connecting the end user 13, 14, 15 to the Internet. Alternatively, any other transmission method may be used, such as a switched circuit telephone connection or SMS transmission.

A simple database in manager 18 recognizes and authenticates the “free-call” subscribers according to their PSTN or MSISDN (or any other Mobile or addressing number which used for their registration). Manager 18 contains the details of the registered subscribers and may use these details for several functions such as Authentication and Registration of the free-call subscribers. Still the standard SIP addressing method such as URI could be used in the “free-call” SIP system. In an embodiment of the present invention, when the user dials a PSTN or MSISDN number from his/her User Terminal, the free-call software in the User Terminal can recognize the session as a SIP session and direct it to the SIP Proxy or SIP server or Authentication and Management manager 18. In another embodiment of the present invention, the free-call subscriber 13, 14 or 15 may activate the free-call program in his/her Terminal before dialing. The SIP system will recognize the dialed number of the callee party, and will convert it to the callee party URI addressing (SIP/URL/IP address or any other standard SIP addressing format). In another embodiment of the present invention, the “free-call” human subscriber selects “free-call” service from his/her terminal (e.g., cell phone, mobile phone, computer, . . . ) and accordingly the free-call software knows to use the free-call service for initiation of the call. In this scenario, the end user terminal recognizes the call as a “free-call” call and generates the call via the “free-call” system. The PSTN, MSISDN or other number or addressing format of the callee party will be recognized and converted to the relevant SIP standard address format URI of the callee party, and will be handled in the rest part of the SIP system as a standard SIP session.

The conversion of the “free-call” number of the callee party to a standard SIP addressing format may be performed, as described above by manager 18, or by any other element of SIP network 11, e.g. a SIP server of the service provider, or SIP Proxy server 19, configured to perform the translation from telephone number to SIP address, by accessing an internal database and optionally if necessary by contacting the relevant data base (Registrar) in manager 18. In some embodiments of the invention, before transmitting a request for translating a telephone number into a SIP address, the free-call software on the user Terminal 13, 14 or 15, checks an internal translation database of previously used numbers and/or of a local database downloaded from manager 18, and only if not found in the local database, is the database on manger 18 accessed. Furthermore, one or more proxy and/or mirror databases may be employed and these may be accessed instead or together with the manager 18 or may be accessed before accessing manager 18 and only if no answers are received from the proxy is manager 18 consulted. So the system data base 18 should have the “free-call” numbers of its clients as well as their SIP addresses.

In some embodiments of the invention, after converting the inserted telephone number into a SIP address, manager 18 returns the SIP address to the free-call software on the users terminal, which establishes a connection with the destination using the SIP address from manager 18. In other embodiments of the invention, manager 18 uses the SIP address to establish a connection with the destination. Manager 18 establishes another connection to the caller, or uses a previously established connection with the caller, and then connects the two connections to each other to allow the caller to communicate with the destination. In this embodiment, the task of the connection with the destination is performed by manager 18, such that the burden on the terminal of the caller is lower.

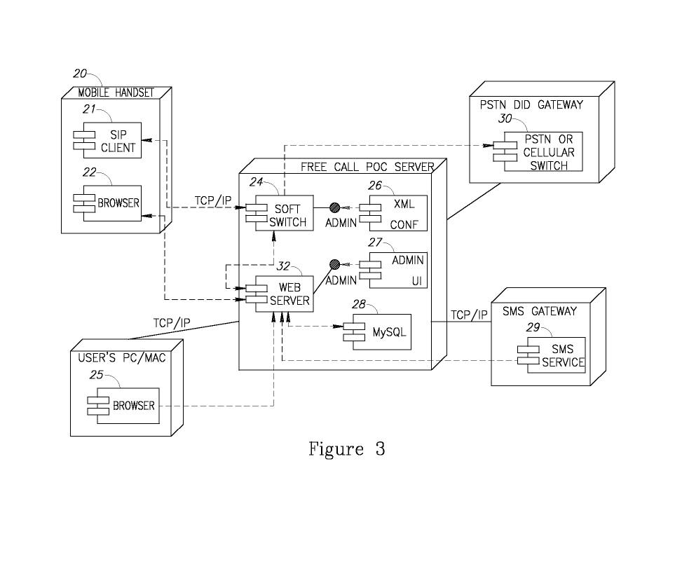

FIG. 3 shows an embodiment of a system SW architecture for the current invention. As an example, the system is connected to the PSTN or Cellular network 30 and enables messaging services 29 as well. The system is a client server architecture, where standard SIP clients (running on Nokia S60 or iPhones for example) connect to a SIP server 24 that interacts with various application servers 26, 27 and 28. Users may also use a client browser 22 or 25 to connect to the web server 32 to register and activate their accounts. The registration and activation process will be carried by users using a standard web browser 32 (such as IE7, IE8, FireFox, Chrome) and calls will be initiated and received on mobile handsets SIP clients or converted to other telephony network 30. All participating components could work over the Internet. The Soft Switch 24 has several configuration files to control parameters such as default codec and dial plan rules. FreeCall will utilize these files and specifically the directory file to establish a list of users who are able to register their SIP clients in the system. The directory configuration file will be first generated by the application server 26 if it does not exist and will be updated upon activation of a new user or deletion of an existing one. This directory file is an XML file 26.

The system can be expanded to allow various other clients to connect to the system. For example SIP trunk to corporate IP PBX (Private Branch Exchange) can be used to allow calling registered users from the corporate offices with fallback to PSTN. The system can be expanded to allow more than a single number to be used for each user, for example the user can “attach” a landline number, or several other mobile numbers, to his/her first number.

SMS validation could be used to prevent the unauthorized use of MSISDN numbers by users who are not actually the owners of these numbers. Upon registration, the system may send an SMS to the registered MSISDN activation code. Only upon entering this code in the web site the user will be considered “Active” and be able to receive calls to this MSISDN.

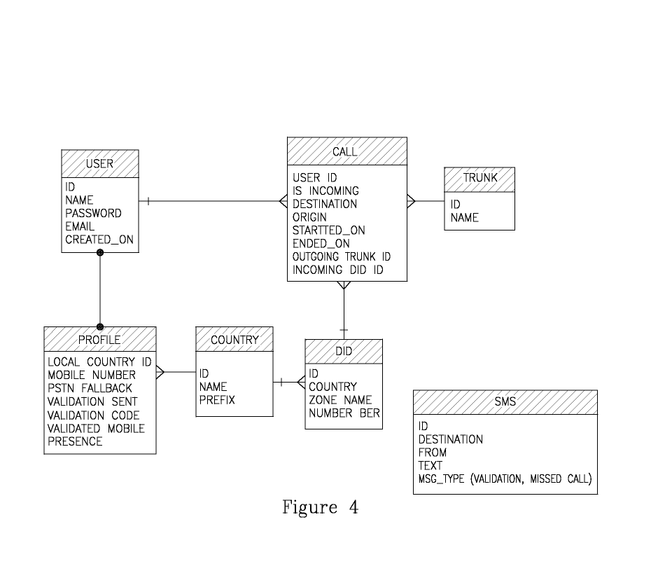

FIG. 4 shows a schematic data base used to store the system's data objects such as: registered users details, call log information and log system events. The database will also allow the creation of call reports.

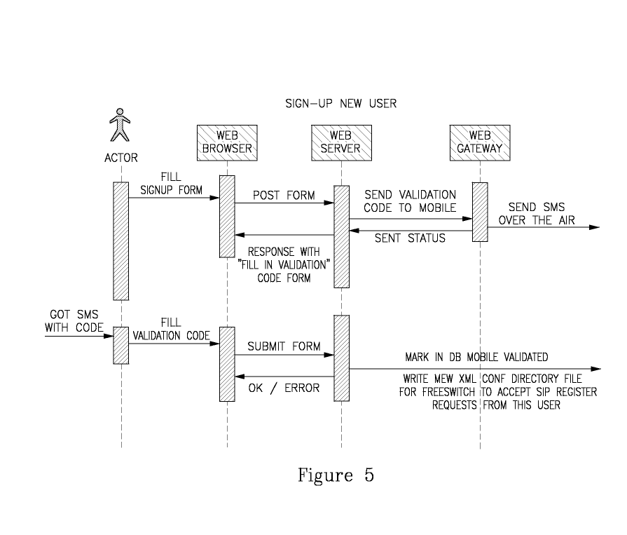

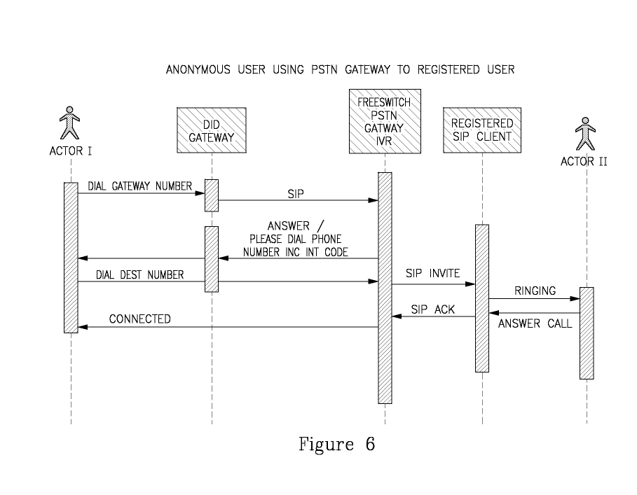

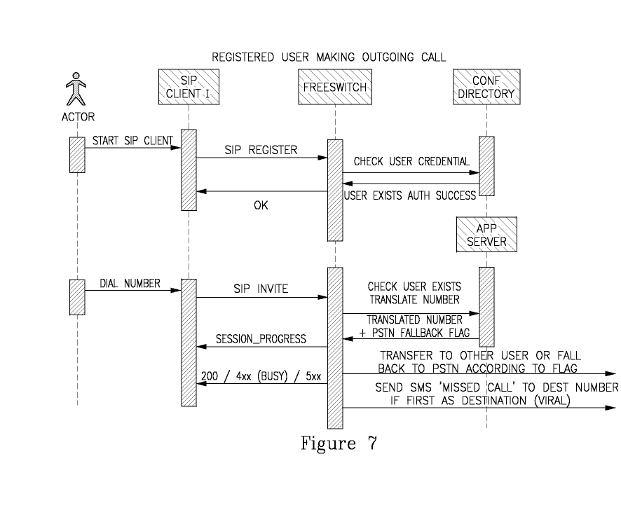

FIGS. 5, 6 and 7 details an example of the procedure for operation of the system. FIG. 5 refers to procedure scenario of sign-up a new user, FIG. 6 shows the procedure of incoming PSTN Gateway call when an anonymous User using PSTN gateway to a registered user. The same procedures could be applied for Cellular Gateways. FIG. 7 shows the procedures for making an outgoing call. Subscribing to the service can be achieved by visiting the application web site either from the user's PC or from a capable mobile handset or smart phones.

1. A method of establishing a communication connection, by a communication unit, comprising:
receiving a telephone number of a destination through a human interface of the communication unit;
transmitting the received telephone number over a data connection to a number translation server; and
establishing a real time communication connection between the communication unit and the destination over a data connection, using the received identifier.

2. The method of claim 1, wherein the received telephone number comprises a telephone number which meets the standards of a public system telephone network (PSTN).

3. The method of claim 1, wherein the received telephone number comprises a telephone number which meets the MSISDN standards of cellular networks.

4. The method of claim 1, comprising checking an internal database for an entry including the received telephone number and a corresponding destination identifier and transmitting the received telephone number only if an entry in the local database is not found.

5. The method of claim 1, wherein, if an identifier corresponding to the telephone number is not received, a real time communication connection between the communication unit and the destination is established over a switched connection.

6. The method of claim 1, further comprising receiving from the server an identifier of the destination for VoIP communications, responsive to the received telephone number, and wherein establishing a real time communication connection is performed by the communication unit.

7. The method of claim 1, wherein establishing a real time communication connection between the communication unit and the destination over a data connection comprises establishing by a server a first connection to the destination and a second connection to the communication unit and connecting the first and second connections to each other.
